(19) United States
(12) Patent Application Publication
(10) Pub. No.: US 2014/0283487 A1
(43) Pub. Date: Sep. 25, 2014

(54) Systems and Methods for Printing Blank Packaging Cartons That are Die Cut and Creased Prior to Entering Printing Process

(71) Applicant: Donald L. Scott, Alpharetta, GA (US)

(72) Inventor: Donald L. Scott, Alpharetta, GA (US)

(21) Appl. No.: 14/224,588

(22) Filed: Mar. 25, 2014

Related U.S. Application Data
(60) Provisional application No. 61/805,015, filed on Mar. 25, 2013.

(51) Int. Cl. B65B 5/02; B31B 1/88

(52) U.S. Cl. CPC B65B 5/024; B31B 1/88
USPC 53/456; 493/55; 53/564

(57) ABSTRACT

A method is provided for printing unprinted, or blank, cartons for packaging that have been cut and creased. The method includes receiving, at a printing apparatus, blank cartons that have been cut and creased to be ready for folding and at least one of gluing, tucking and locking. The printing apparatus is adjusted based on at least one attribute of the blank cartons and configured to print an image before the printing apparatus starts printing the image on the blank cartons. The method also includes printing the image on each of the blank cartons to produce packaging cartons printed with the image. The method may further include automatically separating each blank carton in a multiple-up layout configuration after the image is printed on the blank cartons in the multiple-up layout configuration. In some embodiments, the blank cartons include at least one of uneven side edge(s), an uneven leading edge, and an even trailing edge.

### CROSS-REFERENCE TO RELATED APPLICATIONS

This application claims the benefit under 35 U.S.C. §119(e) of U.S. Provisional Application Ser. No. 61/805,015, filed on Mar. 25, 2013, which is hereby incorporated by reference herein in its entirety.

### FIELD OF THE INVENTION

The subject matter of the invention is related to systems and methods for printing unprinted, or blank, packaging cartons that have been cut and creased.

### DESCRIPTION OF RELATED ART

Consumer packaged goods companies are interested in connecting with their customers through regionalized and customized messaging and promotional opportunities printed on the surface of the package targeted at specific segments of the population or demographic groups. In that way, the consumer can notice the package at the point of sale and want to purchase the product since the promotion adds values to the product purchased or aligns with the brand's image or other marketing methods and messages. One challenge is to produce lower volumes of each stock keeping unit (SKU) to meet specific regional or demographic marketing opportunities economically.

Industry studies indicate that profits generated that are associated with hybrid printing presses with digital imaging capability are approaching twice that of conventional printing presses. Growth in digital image printing business is also ahead of convention printing business. Furthermore, studies show that most run lengths in today's market are between 500 and 20,000 sheets, or sheets of packaging cartons. A challenge is that although the hybrid printing press with digital imaging capability can produce printing jobs economically at run lengths below 20,000 sheets, the savings are offset by an equal and opposite increase in costs related to downstream die cutting, or die cutting and creasing, of the printed sheets, or printed sheets of packaging cartons, into a packaging format, or individual packaging unit.

### SUMMARY

The subject matter of the invention is related to systems and methods for printing unprinted, or blank, packaging cartons that have been cut and creased. More specifically, the invention is related to systems and methods for high-speed printing of unprinted (i.e., blank or partially blank) packaging cartons that are die cut and creased prior to entering the printing process.

Conventional systems that produce product packaging units typically print the media (e.g., graphics and/or messages for product advertisement) related to the products to be packaged using the packaging units prior to processing (e.g., die cutting, creasing, etc.) the packaging units into desired shapes. However, due to the cost related to the downstream die cutting, or die cutting and creasing, the printed packaging cartons, it would not be economical to print less than a certain number (e.g., 20,000) of blank sheets for packaging units. This minimum printing requirement (a.k.a., minimum SKU requirement) in turn entails the need for inventory and safety stocks of packaging units that are ready for packaging intended products.

Because such product related media is pre-printed, consumer packaged goods companies have limited means for supplementing the pre-printed media with additional messages (e.g., applying sticker(s) with additional messages, such as “25% Sale” or “Buy 2 Get 1 Free,” on the surface of packaging units). The consumer packaged goods companies would find it useful to be able to add regionalized and/or more specifically customized images and/or messages. For example, a Coca Cola™ distributor in Los Angeles may want to add a regionalized message (e.g., “Imagine a can of Diet Coke in your hand in Long Beach at sunset!”) in a packaging unit for holding 12 cans of Diet Coke™. A Coca Cola™ distributor in Detroit, on the other hand, may want to print a different message (e.g., “Imagine a can of Diet Coke in your hand on the beach line of Lake Erie!”).

The challenge to produce low volume of individual packaging unit, also referred to as stock keeping unit (SKU), to meet specific regional or demographic marketing opportunities economically, can be addressed through the systems and methods of the present invention, e.g., by combining multiple operations inside a printing process along with package processing and/or converting steps in a novel way (e.g., rearranging such operations and steps in different orders).

In one embodiment, a method is provided for printing unprinted, or blank, cartons for packaging that have been cut and creased. The method includes receiving, at a printing apparatus, blank cartons that have been cut and creased to be ready for folding and at least one of gluing, tucking and locking. The printing apparatus is adjusted based on at least one attribute of the blank cartons and configured to print an image before the printing apparatus receives the blank cartons. The method also includes printing the image on each of the blank cartons to produce packaging cartons printed with the image.

In another embodiment, a system is provided for printing unprinted, or blank, cartons for packaging that have been cut and creased. The system includes a printing apparatus adapted to print an image and configured to receive blank cartons that have been cut and creased to be ready for folding and at least one of gluing, tucking and locking. The printing apparatus has been adjusted based on at least one attribute of the blank cartons. The printing apparatus is also configured to print the image on each of the blank cartons to produce packaging cartons printed with the image.

In yet another embodiment, a method is provided for printing unprinted, or blank, cartons for packaging that have been cut and creased. The method includes receiving, at a printing apparatus, blank cartons formed in a multiple-up layout configuration that have been cut and creased to be ready for folding and at least one of gluing, tucking and locking. The printing apparatus is adjusted based on at least one attribute of the blank cartons and configured to print an image before the printing apparatus starts printing the image on the blank cartons. The method also includes printing the image on each of the blank cartons to produce packaging cartons printed with the image. The method further includes automatically separating each blank carton in the multiple-up layout configuration after the image is printed on the blank cartons in the multiple-up layout configuration, and automatically constructing, at a packaging apparatus, a packaging unit from each of the packaging cartons by folding and at least one of gluing, tucking and locking the packaging cartons. The method also includes automatically placing, at the packaging apparatus, a product or a set of products into each of the constructed packaging units, and automatically sealing the packaging units containing the product or the set of the products by at least one of gluing, tucking, and locking the packaging units.

### BRIEF DESCRIPTION OF THE DRAWINGS

FIG. 1 is a block diagram of a system for printing unprinted, or blank, cartons for packaging that have been cut and creased in accordance with one embodiment of the present invention.

FIG. 2 illustrates a device used for separating printed packaging cartons in a multiple-up layout configuration into individual cartons in accordance with one embodiment of the present invention.

FIG. 3A is a schematic showing a 2-up layout of a blank carton with single knife between the layout in accordance with one embodiment of the present invention.

FIG. 3B is a schematic showing a 2-up layout of a blank carton without knife (after knife is eliminated) in accordance with one embodiment of the present invention.

FIG. 3C is a schematic showing a 1-up layout of a blank carton in accordance with one embodiment of the present invention.

FIGS. 3D-3E are schematics showing a 2-up layout adapted for single knife production in accordance with one embodiment of the present invention.

FIG. 4 is a block diagram for a method for printing unprinted, or blank, cartons for packaging that have been cut and creased in accordance with one embodiment of the present invention.

### DETAILED DESCRIPTION

The subject matter of the invention is related to systems and methods for printing unprinted, or blank, cartons for packaging that have been cut and creased. The benefit of die cutting, or die cutting and creasing, prior to entering printing process is that economies of sales related to large format high-speed die cutting, or die cutting and creasing, are maintained, allowing the economic and environmental benefit of die cutting and creasing blank sheets of packaging cartons prior to entering the printing process.

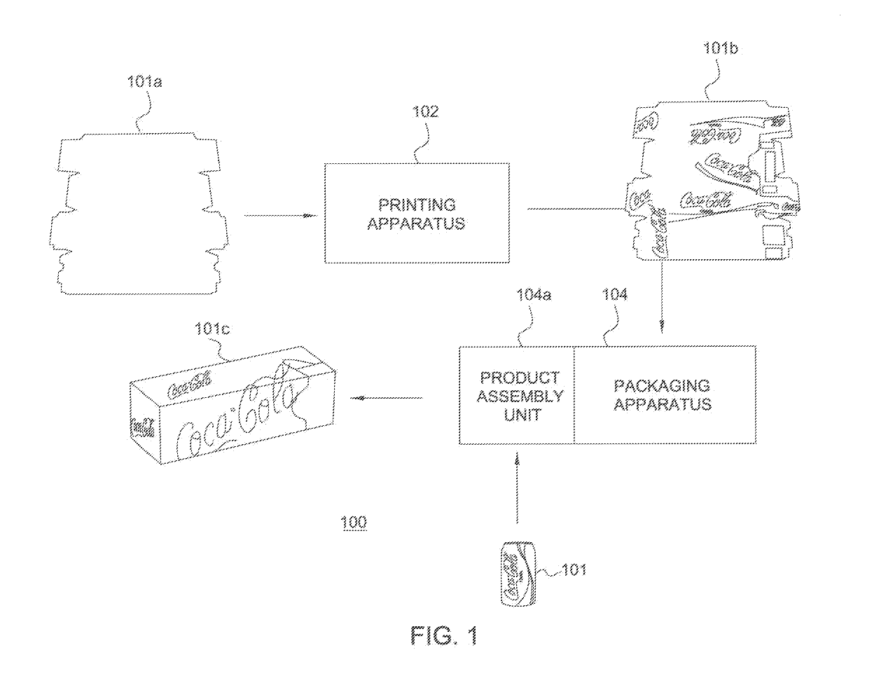

FIG. 1 is a block diagram of a system 100 for printing unprinted, or blank, cartons 101a (for packaging) that have been cut and creased in accordance with one embodiment of the present invention. System 100 includes a printing apparatus 102 and a packaging apparatus 104. Printing apparatus 102 is configured to receive blank cartons 101a, which have been die cut and creased, and print an image (e.g., advertising graphics and/or messages), or images, on the blank cartons to produce packaging cartons 101b printed with the image. In some embodiments, printing apparatus 102 includes a hybrid printing press with digital imaging capability. In some embodiments, printing apparatus 102 is adjusted prior to the printing based on one or more attributes of blank cartons 101a, as well as the image selected for printing.

In some embodiments, blank cartons 101a are manually fed through a blank carton feed attached to printing apparatus 102. In some embodiment, blank cartons 101a are received directly from a separate apparatus, which is adapted to receive blank sheets and produce blank cartons, such as blank cartons 101a, by die cutting, or die cutting and creasing, the blank sheets in accordance with a preset configuration.

Attributes of blanks cartons 101a may include one or more of shape, size, style, and thickness of the blanks cartons. The style of blank cartons 101a may include one or more of reverse tuck, straight tuck, seal end, lock form, glue form, auto bottom, 4-corner, 6-corner, and wraparound. In some embodiments, the thickness of blank cartons 101 a is in a range of between 0.001 and 0.002 inches.

In some embodiments, blank cartons 101a include one or more of at least one uneven side edge, an uneven leading edge, and an uneven trailing edge. In some embodiments, blank cartons 101a are formed in a multiple-up layout, or multiple-up layout configuration (e.g., including 2-up layout configuration).

In some embodiments, printing apparatus 102 uses conventional standard flexible, paperboard based materials for production, as well as waterless offset inks and aqueous coatings. This is advantageous because convention packaging materials, inks and coatings serve to lower packaging costs when compared to digital or ink jet methodologies. In addition, conventional inks and coatings are deemed safe when used in packaging for indirect contact with food products.

In some embodiments, printing apparatus 102 is configured for creating multicolor, detailed, high resolution graphics on, e.g., packaging film or folding cartons, with screen ruling of 300 lines per inch, as well as stochastic processing. In some embodiments, system 100 further enables three-dimensional (3D) printing, cold foiling and casting of holographic images into the printed surface of packaging cartons 101b.

Packaging apparatus 104 is configured to receive packaging cartons 101b printed with a selected image and construct a packaging unit 101c from each packaging carton 101b by, e.g., folding and gluing, tucking, and/or locking packaging carton 101b. In some embodiments, packaging apparatus 104 includes a product assembly unit 104a, which is configured to receive a product 101, or a set of products 101, insert product(s) 101 into packaging unit 101c, and seal packaging unit 101c by, e.g., gluing, tucking, and/or locking.

In some embodiments, printing apparatus 102 is in line with, or adjacent to, packaging apparatus 104 such that each packaging carton 101b printed with the image is automatically sent to packaging apparatus 104. This arrangement enables stand-alone batch printing for just-in-time-delivery of packaged products or packaging materials. Just-in-time-delivery in turn helps eliminate the need for inventory and safety stocks that are normally associated with production of packaging materials. Elimination of the need for inventory and safety stocks (a condition referred to as “net zero inventory”) in turn further reduces working capital and prevents obsolescence (e.g., attributes of a product, for which many packaging cartons printed with an image are produced, are changed in a way that is inconsistent with the printed image, thereby making the remaining packaging cartons obsolete)

In some embodiments, system 100 enables printing for both primary packaging (e.g., packaging soft drink into a 16 oz. can) and secondary packaging (e.g., packaging a set of 16 oz. soft drink cans into a 12-can packaging unit) with product specific information (e.g., graphic and textual information) in a stand-alone installation, wherein system 100 is positioned adjacent to a packaging line or in a centralized location within or adjacent to a packaging plant.

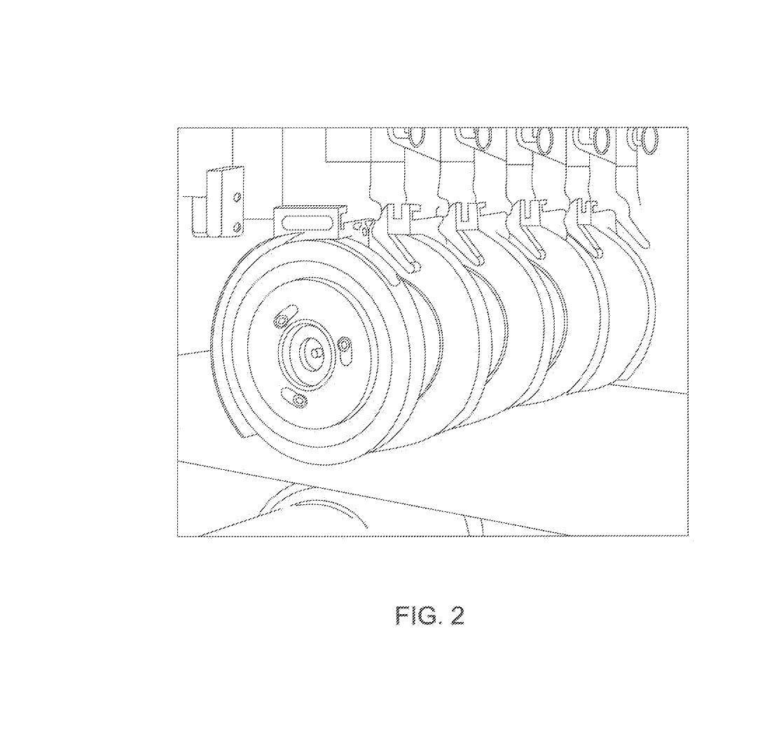

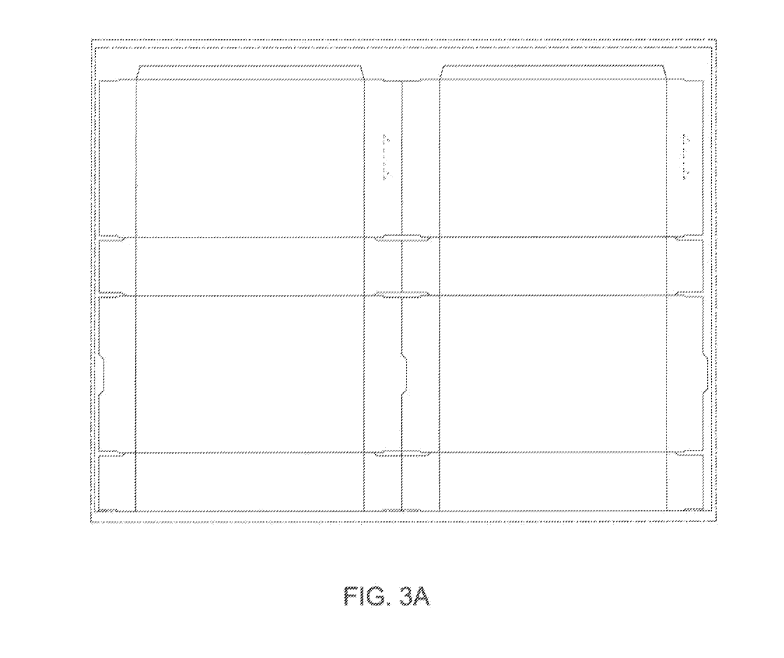

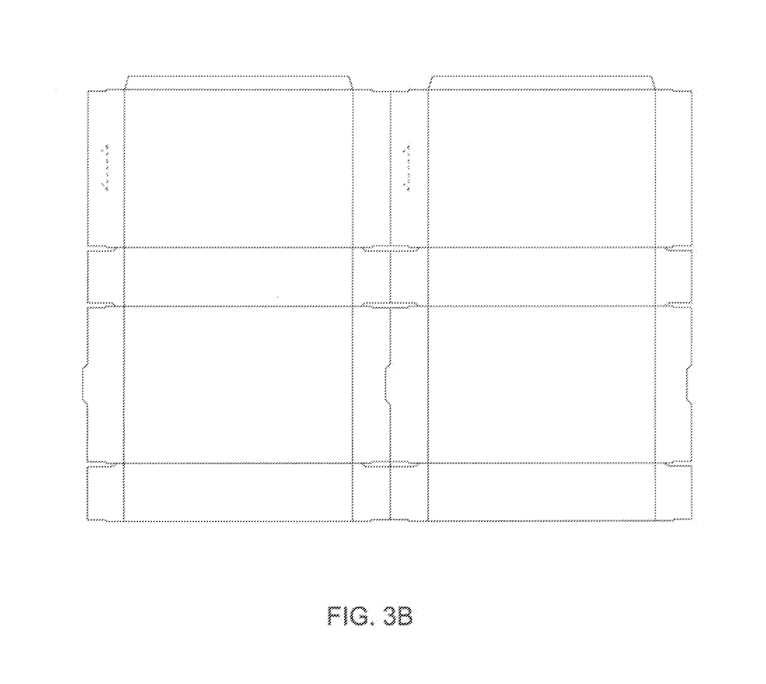

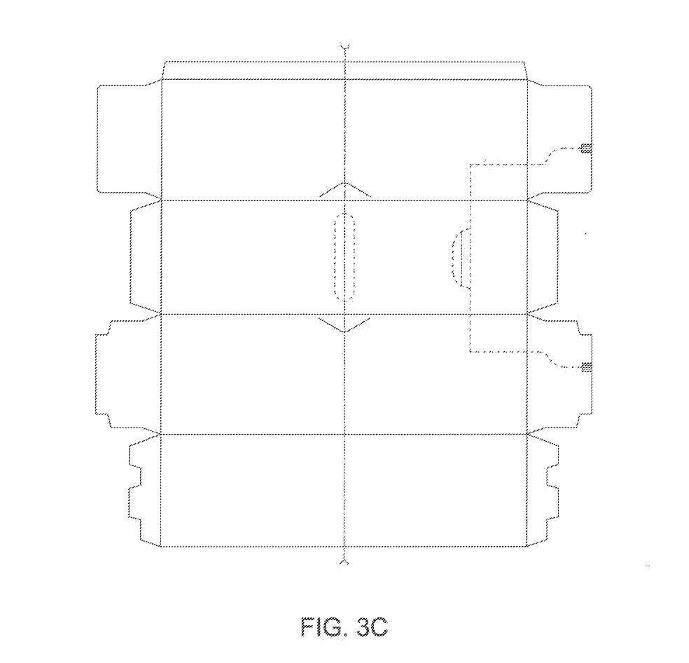

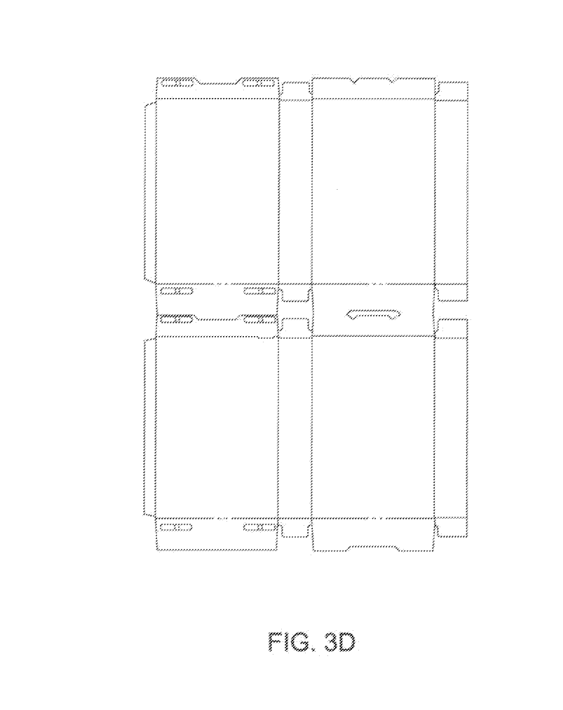

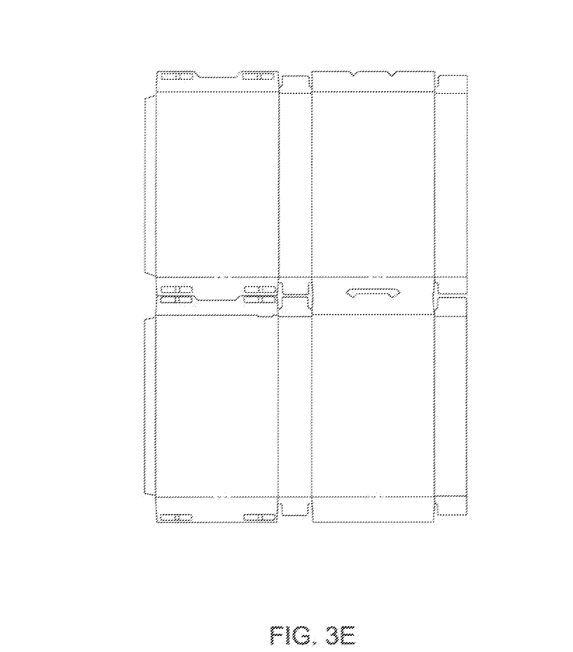

In the embodiments in which packaging cartons 101b are in a multiple-up layout configuration, packaging apparatus 104 is further configured to separate individual packaging cartons 101b from the multiple-up layout configuration. In some embodiments, packaging apparatus 104 includes a device (e.g., an air knife) that is adapted for separating individual packaging cartons 101b from a multiple-up layout configuration (e.g., 2-up, 4-up, or 8-up layout configuration). In some embodiments, the separation step is performed at printing apparatus 102. FIG. 2 is an image of a device that is used for separating printed packaging cartons in a multiple-up layout configuration into individual cartons. FIGS. 3A-3E are schematics showing exemplary blank carton layout configurations in accordance with embodiments of the present invention.

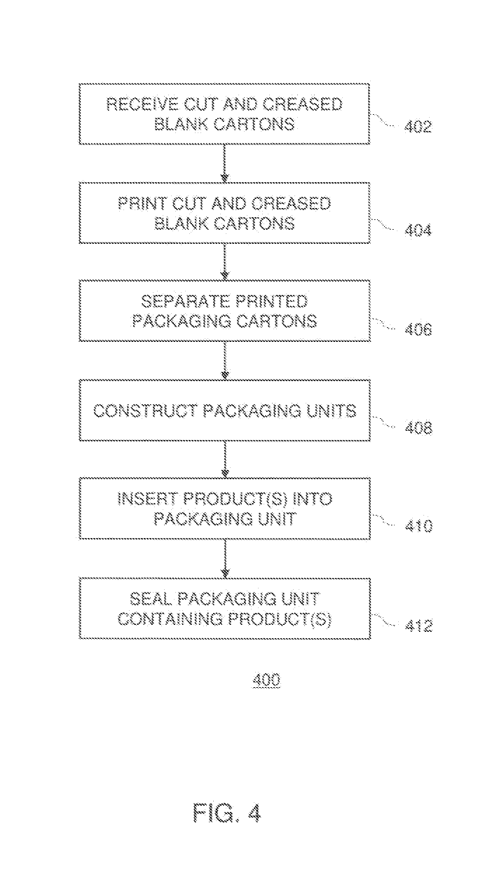

FIG. 4 is a block diagram for a method 400 for printing unprinted, or blank, cartons for packaging that have been cut and creased in accordance with one embodiment of the present invention. At 402, blank cartons 101a that have been die cut and creased in accordance with a preset configuration are received at printing apparatus 102. In some embodiments, blank cartons 101a are fed manually, e.g., some time after they are produced in a separate process and delivered. In some embodiments, blank cartons 101a are received from a separate apparatus, which is coupled to printing apparatus 102 and adapted to produce blank cartons 101a by die cutting, or die cutting and creasing, blank sheets.

Blank cartons 101b may include one or more of uneven side edge(s) and a leading and/or a trailing edge. In some embodiments, blank cartons 101a are received at printing apparatus 102 from another apparatus or device that is a part of a stand-alone or inline package processing arrangement/configuration. In some embodiments, a continuous sheet of blank cartons formed in a multiple-up layout configuration is fed to printing apparatus 102.

At 404, printing apparatus 102 prints selected images(s), or images and messages, on blank cartons 101a, which have been die cut, or die cut and creased. In some embodiments, printing apparatus 102 is adjusted based on one or more attributes of blank cartons 101a prior to the printing of the image/messages. The attributes of blank cartons 101a may include one or more of size, style, shape, and thickness of blank cartons 101a.

At 406, packaging cartons 101b printed with the selected image(s) are separated, if the cartons are formed in a multiple-up layout configuration, such as 2-up, 4-up, or 8-up layout configuration. In some embodiments, packaging cartons 101b are separated at printing apparatus 102. In some embodiments, packaging cartons 101b are separated at packaging apparatus 104.

At 408, packaging units 101c are constructed from packaging cartons 101b at packaging apparatus 104 by, e.g., folding and gluing, tucking, and/or locking packaging cartons 101b.

At 410, product 101, or a set of products 101, is/are inserted into packaging units 101c at packaging apparatus 104. In some embodiments, packaging apparatus 104 includes product assembly unit 104b that is configured/adapted for receiving and inserting product(s) 101 into packaging units 101c. In some embodiments, product assembly unit 104b is a separate apparatus that is coupled to packaging apparatus 104 in an inline, or a stand-alone, arrangement. In some embodiments, product 101 is a food product, including solid (e.g., breakfast cereal) as well as liquid (e.g., soft drink) food products.

At 412, packaging units 101c containing product(s) 101 are sealed at packaging apparatus 104 (e.g., at product assembly unit 104a) by, e.g., folding, gluing, tucking, and/or locking.

While there have shown and described and pointed out fundamental novel feature of the invention as applied to preferred embodiments thereof, it will be understood that various omissions and substitutions and changes in the form and details of the systems and methods illustrated, and in their operation/steps, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method comprising:
receiving, at a printing apparatus, blank cartons that have been cut and creased to be ready for folding and at least one of gluing, tucking and locking, wherein the printing apparatus is configured to print an image and adjusted based on at least one attribute of the blank cartons before the printing apparatus starts printing the image on the blank cartons; and
printing the image on each of the blank cartons to produce packaging cartons printed with the image.

2. The method of claim 1, wherein the blank cartons are formed in a multiple-up layout configuration.

3. The method of claim 2, further comprising automatically separating each blank carton in the multiple-up layout configuration after the image is printed on the blank cartons in the multiple-up layout configuration.

4. The method of claim 2, wherein the multiple-up layout configuration includes a 2-up layout.

5. The method of claim 1, wherein the printing apparatus comprises a printing press.

6. The method of claim 5, wherein the printing press comprises a hybrid printing press capable of performing both analog printing and digital imaging.

7. The method of claim 1, wherein the blank cartons include at least one of uneven side edge(s), an uneven leading edge, and an even trailing edge.

8. The method of claim 1, wherein the at least one attribute of the blank cartons comprises one or more of shape, size, style, and thickness of the blank cartons.

9. The method of claim 8, wherein the style of the blank cartons comprises one or more of reverse tuck, straight tuck, seal end, lock form, glue form, auto bottom, 4-corner, 6-corner, and wrap-around.

10. The method of claim 8, wherein the thickness of the blank cartons is in a range of between 0.001 and 0.002 inches.

11. The method of claim 1, wherein the blank cartons are die cut.

12. The method of claim 1, wherein the packaging cartons are placed for a packaging process.

13. The method of claim 12, wherein the packaging cartons are sent to a packaging apparatus configured to construct a packaging unit from each of the packaging cartons by folding and at least one of gluing, tucking and locking the packaging cartons.

14. The method of claim 13, wherein the packaging apparatus is coupled to the printing apparatus such that each of the packaging cartons is automatically sent to the packaging apparatus.

15. The method of claim 13, wherein the packaging apparatus is further configured to place a product or a set of products into each of the constructed packaging units and seal the constructed packaging units containing the product or the set of products by at least one of gluing, tucking, and locking the packaging units.

16. A system comprising:
a printing apparatus adapted to print an image and configured to:
receive blank cartons that have been cut and creased to be ready for folding and at least one of gluing, tucking and locking, wherein the printing apparatus has been adjusted based on at least one attribute of the blank cartons; and
print the image on each of the blank cartons to produce packaging cartons printed with the image.

17. The system of claim 16, further comprising a packaging apparatus configured to construct a packaging unit from each of the packaging cartons by folding and at least one of gluing, tucking, and locking the packaging cartons.

18. The system of claim 17, wherein the printing apparatus is in-line with the packaging apparatus such that each of the packaging cartons printed with the image is automatically sent to the packaging apparatus.

19. The system of claim 17, wherein the packaging apparatus is further configured to place a product or a set of products into each of the constructed packaging units and seal the packaging units containing the product or the set of the products by at least one of gluing, tucking, and locking the packaging units.

20. A method comprising:
receiving, at a printing apparatus, blank cartons formed in a multiple-up layout configuration that have been cut and creased to be ready for folding and at least one of gluing, tucking and locking, wherein the printing apparatus is configured to print an image and adjusted based on at least one attribute of the blank cartons before the printing apparatus starts printing the image on the blank cartons;
printing the image on each of the blank cartons to produce packaging cartons printed with the image;
automatically separating each blank carton in the multiple-up layout configuration after the image is printed on the blank cartons in the multiple-up layout configuration;
automatically constructing, at a packaging apparatus, a packaging unit from each of the packaging cartons by folding and at least one of gluing, tucking and locking the packaging cartons;
automatically placing, at the packaging apparatus, a product or a set of products into each of the constructed packaging units; and
automatically sealing the packaging units containing the product or the set of products by at least one of gluing, tucking, and locking the packaging units.
